(19) United States
(12) Patent Application Publication
(10) Pub. No.: US 2008/0317900 A1
(43) Pub. Date: Dec. 25, 2008

(54) Feed, or Feed Additive, for Livestock Weight Increase

(75) Inventor: Masahiro Yamamoto, Kagoshima (JP)

Correspondence Address: PEARNE & GORDON LLP, 1801 EAST 9TH STREET, SUITE 1200, CLEVELAND, OH, 44114-3108, US

(73) Assignees: Noriko Yamamoto, Kagoshima (JP); Masahiro Yamamoto, Kagoshima (JP)

(21) Appl. No.: 12/091,141

(22) PCT Filed: Oct. 27, 2006
(86) PCT No.: PCT/JP2006/321527

§ 371 Date: Jun. 30, 2008

(30) Foreign Application Priority Data
Oct. 27, 2005 (JP) 2005-312273

(51) Int. Cl. A23K 1/14

(52) U.S. Cl. 426/2; 426/635

(57) ABSTRACT

[Problem] To promote the early weight increase of livestock, reduce blood triglyceride levels and obtain good meat quality.

[Solution] The invention offers a feed composition comprising 0.01-1 wt % of koji obtained by growing Aspergillus on a substrate containing a substance anaerobically fermented by a yeast. Additionally, it offers a livestock raising method comprising feeding the livestock a feed composition obtained by adding, to a common feed composition, koji in an amount of 0.01-1 wt % with respect to the total weight of the feed composition. In particular, the koji is obtained by growing Aspergillus on a substrate containing a substance anaerobically fermented by a yeast, the Aspergillus being chosen from the group consisting of Asp. oryzae, Asp. awamori and Asp. sojae.

### TECHNICAL FIELD

The present invention relates to a feed composition, a feed composition additive and a method for promoting the growth of livestock.

### BACKGROUND ART

The early fattening of livestock meets the needs of livestock farmers. Conventionally, maize, soy beans, wheat, hay, molasses, beet pulp and wheat bran have been used as feed compositions. Additionally, the use of wheat bran treated with koji has been proposed (Patent Document 1).

Koji is a fermented food product that has long been indispensable to the Japanese diet, being used in miso, soy sauce, amazake, vinegar, sake and shochu, and the koji ingredient plays a major role in promoting the health of the Japanese. There are studies that have reported that use of this koji in feed compositions for livestock can be expected to have many effects such as reduced odor of excrement and improved health (Patent Document 2).

### Patent Document 1: JP 64-20090A1

### Patent Document 2: JP 2002-142688A1

### DISCLOSURE OF THE INVENTION

### Problems to be Solved by the Invention and Means for Solving the Problems

The applicants of the present application performed diligent research into how to achieve early weight increase, improved meat quality and productivity when fattening livestock, as a result of which they discovered that maximal early weight increase and meat quality improvement effects can be achieved by adding about 0.01-1 wt % of Aspergillus koji to a feed composition. Thus, the present invention offers a feed composition containing 0.01-1 wt % of Aspergillus koji, especially koji obtained by growing Aspergillus on a substrate containing alcohol fermentation residues, and a livestock raising method using said feed composition.

The amount of koji added is preferably at least 0.03 wt % and less than 0.5 wt % with respect to the entire feed composition. More preferably, it is at least 0.05 wt % and less than 0.1 wt %. Most effectively, about 0.05 wt % of koji should be added to the feed composition.

As a result, the feed composition offered by the present invention is capable of effectively promoting the fattening of livestock. Additionally, the triglycerides in the blood are reduced by the ingestion of the feed composition of the present invention, thus resulting in good meat quality.

The amount of koji added to the feed composition of the present invention is extremely small compared to conventional koji-containing feeds such as that proposed in Patent Document 1. Conventionally, at least a few wt % of koji was added to improve the taste of the feed composition so as to ensure greater intake of the feed composition and improve the nutritional value of the feed composition due to fermentation, thus to better promote the fattening of livestock. However, in the present invention, a maximal effect is achieved with a minimal amount of koji added, so the mechanism here seems to differ from that of conventional koji-containing feed compositions. For example, certain components of microbial products seem to physiologically affect the growth of livestock in the manner of a growth promotion factor.

For the purposes of the present invention, “koji” shall refer to koji mold (Aspergillus) grown on a substrate. The microbial content of koji can be represented by the amount of glucosamine contained in the cell walls of the koji (Arima et al., “A New Method for Estimation of the Mycelial Weight in Koji”, Agr. Biol. Chem., Vol. 31, No. 1, pp. 119-123, 1967). The koji of the present invention should preferably contain at least 0.05 μg, more preferably at least 0.07 μg of glucosamine per mg of koji by dry weight.

In the present invention, the “koji” of Aspergillus is a koji in which only Aspergillus is substantially present as a live microbe, or Aspergillus is predominant. Additionally, when subjected to hot molding, only Aspergillus is substantially present as a live microbe, or Aspergillus is predominant in the koji prior to heating.

As the substrate, a substance that is conventionally used for the production of koji may be used. For example, a fibrous substance and/or a starchy substance such as wheat bran, barley bran, rice bran, hay, beet pulp, rice, wheat, rolled barley, wheat, oats, rye, soybeans, maize, corn cobs, sawdust and mixtures thereof can be used as the substrate. A substrate containing wheat bran is preferably used.

Additionally, other raw materials capable of being fermented by Aspergillus may be used, including food wastes such as juice pulp, food scraps, molasses, tofu residues and seafood processing wastes, and farming wastes such as fowl droppings, used either alone or in combination with the above-described fibrous or starchy substrates.

In the present invention, the substrate includes a substance that has been anaerobically fermented by a yeast. Substances that have been anaerobically fermented by a yeast include, for example, residues remaining after extraction of alcohol by distillation, pressing or filtration from an enzyme-cultured substance such as koji, a glycosylated substance or a sugar-containing substance that has been anaerobically fermented with a yeast in the production of alcohol. Substances that have been anaerobically fermented by yeasts especially refer to alcohol fermentation effluents, distillation effluents and shochu effluents, which substances contain dead yeasts.

By using a koji obtained by fermenting a substrate containing a substance anaerobically fermented by a yeast, the effects of the present invention are further improved. The improved effects have been confirmed by the high correlation between the weight increase efficiency and the amount of anaerobic fermentation by yeasts. Therefore, the koji used in the present invention is preferably obtained by mixing a substance anaerobically fermented by a yeast with a fibrous or starchy raw material, and fermenting with Aspergillus. In particular, it can be obtained by growing Aspergillus on a mixture of wheat bran and a substance anaerobically fermented by a yeast.

Additionally, if the substrate contains oils, the Aspergillus will feed on the oils and convert them efficiently to fermentation heat, thus greatly increasing the speed of decomposition and drying of the raw material by the Aspergillus. Furthermore, since there are few naturally occurring microbes that are able to feed on oils, Aspergillus, which is easily affected by contaminants such as other microbes, can be made to grow with predominance.

The Aspergillus should preferably be Asp. oryzae, Asp. awamori, Asp. sojae, and more preferably Asp. oryzae kawachii or Asp. awamori kawachii (Kawachi Genichiro Shoten). Additionally, the koji may contain other bacteria or molds such as Monascus within such a range as not to hinder the growth of the Aspergillus.

Koji can be prepared by adding Aspergillus preferably to a substrate containing a starchy substance or an oil, and culturing preferably for at least 24 hours, more preferably for at least 40 hours in accordance with conventional methods. While the culturing time will differ depending on the raw materials used, it should be sufficient to enable the Aspergillus to adequately grow on the substrate and dry the koji to a water content of 30 wt % or less, preferably 20 wt % or less, and more preferably 15 wt % or less. If the water content is greater than this, the substrate is less able to endure prolonged storage and is susceptible to putrefaction.

The Aspergillus koji is used by mixing it with a common feed composition.

For the purposes of the present invention, a “common feed composition” can be of many types that are publicly known, such as barley, rice, soybeans, maize, hay, molasses, beet pulp and wheat bran.

The feed composition obtained by the present invention can be used to feed various types of livestock including cattle, swine, chickens, sheep and horses. Preferably, the feed composition is used for chickens.

### BRIEF DESCRIPTION OF THE DRAWINGS

FIG. 1 is a graph showing the results of Example 1.

FIG. 2 is a graph showing the amino acid digestion rate in Example 2.

### BEST MODES FOR CARRYING OUT THE INVENTION

Herebelow, a preferred embodiment of the present invention shall be explained.

First, Aspergillus is added to a substrate.

The substrate can be selected, for example, from among wheat bran, barley bran, rice bran, hay, beet pulp, rice, barley, rolled barley, wheat, oats, rye, soybeans, maize, corn cobs, sawdust and mixtures thereof. Alternatively, it is possible to use food wastes such as juice pulp, food scraps, molasses, tofu residues and seafood processing wastes, and farming wastes such as fowl droppings, either alone are together with these substrates.

Furthermore, the substrate contains a substance anaerobically fermented by a yeast, such as an alcohol extraction residue from alcohol production. Alcohol extraction residues (alcohol fermentation effluents) are the residues left after extraction of alcohol from cereals or fruits and vegetables, particularly wheat, rice, sweet potatoes, maize and molasses, which are generated during the production of ethanol and drinking alcohols such as shochu.

Since starchy raw materials and lipids can be sources of fermentation energy, these are preferably included in the substrate. In particular, the starch equivalent should preferably be at least 15% or the oil content should be at least 5%. Additionally, other raw materials held to be useful in the field of feeds can be added. In order to prevent contamination by other microbes, the raw material should preferably be subjected to steam sterilization, a hot oil treatment or addition of oils.

The water content of the substrate should preferably be adjusted to a water content that is suitable for growth of Aspergillus by selecting the raw material, adjusting the mixing ratio, adding water and drying the raw material. The water content should preferably be controlled to 50% or less, more preferably 25-40%; and the water activity should be controlled to 0.87 or less, preferably 0.9 or less.

The substrate material is cooled to a temperature suitable for growth of Aspergillus, preferably 30-40° C., after which Aspergillus is added, and the substrate is stirred well. Examples of Aspergillus include Asp. oryzae, Asp. awamori and Asp. sojae, and more preferably Asp. oryzae kawachii or Asp. awamori kawachii (Kawachi Genichiro Shoten). Since Aspergillus grows during the culturing process, the amount of seed koji with which the substrate is inoculated may be small, such as 0.01-0.5% with respect to the whole.

Soon after the Aspergillus is added, the growth of the Aspergillus is accompanied by heat and the product temperature gradually rises.

Thereafter, it should be held in an isothermic tank at a temperature of 35-50° C., and cooled by blowing air if necessary. The drying can be made more effective by blowing air heated to 50-60° C. When the fermentation by the Aspergillus begins, the fermentation heat causes some of the moisture to evaporate. As a result, the product can be dried to a necessary water content. The final target water content of the koji is 30 wt % or less, preferably 20 wt % or less, and more preferably 15 wt % or less. When the water content is greater than 30 wt %, the product is less able to endure prolonged storage and is susceptible to putrefaction.

The fermentation time is preferably at least 24 hours, and more preferably at least 40 hours.

Furthermore, upon reduction of the water content, preferably upon reaching a water content of about 20%, a raw material of high water content can be further added and stirred to adjust the water content to about 30%, and this can be repeated a number of times.

As a result, the growth of bacteria is suppressed, so the Aspergillus grows predominantly, preferably exclusively, to obtain a koji that is abundant in mold filaments. The Aspergillus koji preferably contains at least 0.05 μg/mg, more preferably at least 0.07 μg/mg of glucosamine with respect to the dry weight of koji.

Additionally, the koji obtained in this way can be formed into pellets, for example, by hot molding, to make it more easy to use as a feed. Even if the koji is subjected to a heat treatment at a high temperature, the effects of the present invention, that is, the effects of providing the feed composition with excellent productivity and rates of digestion, are preserved.

The koji is used by mixing it into a conventional feed as a feed additive. The amount added should be 0.01-1 wt %, preferably 0.03-0.5 wt %, more preferably 0.05-0.1 wt % with respect to the feed composition overall. The feed composition into which it is mixed is a common feed composition such as, in particular, barley, rice, soybeans, maize, hay, molasses, beet pulp and wheat bran, and other conventional feed composition additives may be mixed in within such a range as not to hinder the effects of the present invention.

### EXAMPLE 1

A feed composition additive was produced by the following method.

1. 100 kg of rice were immersed in water and boiled to adjust the water content to 42%, and used as the raw material into which Asp. awamori spores were mixed at a concentration of 100,000/g to form koji over a period of 40 hours while maintaining the temperature at 35-40° C.
2. 120 liters of water were added to the resulting rice koji, and a yeast (Saccharomyces cerevisiae) was added at a concentration of 100,000/ml.
3. The fermentate was fermented at 25° C. over a period of 10 days, then dried under reduced pressure at 50° C., and the water content was adjusted to 60% to obtain 30 liters of a concentrate.
4. 30 kg of wheat bran were added to this concentrate to adjust the water content to 35%, then the product was steamed, and Asp. awamori was used again in the same manner as in step 1 to form koji over a period of 120 hours, resulting in a product with a water content of 14%.

The glucosamine content of the resultant product was 0.2 mg/g.

### EXAMPLE 2

Feeding tests were performed with 12-day old broilers (Cobb, male), and the amount of feed ingested, weight increase, feed demand, muscle weight, visceral weight, visceral fat, viscosity and ileal digestion rate were measured.

The broilers were fed a basic feed composition (the ingredients and composition are shown in Table 1) with maize and soybean meal as the main ingredients until they were 15 days old, then they were given the feed compositions in the following test groups until 27 days old.

### Test Groups:

(1) Control (n=7): basic feed composition
(2) Koji feed-added test group (n=7): feed additive (0.05%) and basic feed (99.95%)
(3) Heated feed-added test group (n=7): feed additive treated for 1 minute at 85° C. (0.05%) and basic feed (99.95%)

TABLE 1
Ingredients and Composition of Basic Feed

| Raw Material | (%) |
|---|---|
| Maize | 56.7 |
| Soy meal | 36.5 |
| Maize oil | 2.72 |
| Methionine | 0.22 |
| Vitamin mixture 1 | 0.26 |
| Mineral mixture 2 | 3.30 |
| Cr₂O₃ | 0.30 |
| Composition | |
| Crude protein (%) | 21.20 |
| Metabolic energy (kcal/kg) | 3000 |
| Methionine (%) | 0.55 |
| Lysine (%) | 1.13 |
| Calcium (%) | 1.00 |
| Phosphorus (%) | 0.55 |

The feed composition additive was one obtained by adding a shochu effluent to wheat bran and growing Aspergillus therein, with the following Aspergillus population and enzymatic activity.

TABLE 2
Population and Enzymatic Activity of Koji Feed

| Koji Mold | | |
|---|---|---|
| Aspergillus | 3 x 10⁶ | cells/g |
| Enzymatic Activity | | |
| Acidic protease | 10000 | U/g |
| α-amylase | 40 | U/g |
| Pectinase | 30 | U/g |
| Phytase | 10 | U/g |
| Glucoamylase | 5 | U/g |
| Cellulase | 4 | U/g |

The weight increase, amount of feed ingested, feed demand, digestive tract, liver, visceral fat weight and yield are shown in the following tables.

TABLE 3

| | | Weight | | |
|---|---|---|---|---|
| | | Increase | Feed Ingested | |
| | | (g/12 days) | (g/12 days) | Feed Demand |
| (1) | Control | 707 ± 77 | 1123 ± 85 | 1.59 ± 0.07 |
| (2) | Koji feed added | 730 ± 119 | 1004 ± 92 | 1.38 ± 0.15 |
| (3) | Heated feed added | 705 ± 95 | 1044 ± 106 | 1.48 ± 0.14 |

In the koji feed-added test group and the heated feed-added test group, there was not much difference in weight increase despite a decrease in amount of feed ingested as compared with the control. In other words, the koji feed-added test group and the heated feed-added test group had a low feed demand and an excellent weight increase rate. In particular, the koji feed-added test group showed a weight increase of 15% over the control.

TABLE 4

| | | Dig. Tr. Wt. | Liver Wt. | Visc. Fat Wt. | Yield |
|---|---|---|---|---|---|
| | | (g/100 g BW) | (g/100 g BW) | (g/100 g BW) | (g/100 g BW) |
| (1) | Control | 11.44 ± 0.46 | 2.65 ± 0.28 | 0.37 ± 0.15 | 68.6 ± 1.5 |
| (2) | Koji feed added | 11.81 ± 1.11 | 2.76 ± 0.32 | 0.47 ± 0.18 | 70.0 ± 1.6 |
| (3) | Heated feed added | 11.46 ± 1.16 | 2.80 ± 0.22 | 0.31 ± 0.14 | 70.4 ± 1.4 |
| | (2) & (3) vs. (1) | NS | NS | NS | * |

No difference was observed in the weights of the digestive tract, the liver and the visceral fat between the test groups, while the yield improved over that of the control in the koji feed-added test group and the heated feed-added test group. No increase in GOT value was observed with the feed composition of the present invention.

TABLE 5

| | GOT (mg/dl) |
|---|---|
| Control | 203.5 |
| 0.5 g/kg | 205.7 |
| 10 g/kg | 181.9 |
| S.E.M. | 5.7 |
| Koji feed vs. Control | NS |
| 0.5 vs. 10 g/kg | NS |

GOT: Glutamic Oxaloacetic Transaminase

The effects of the koji feed and heated feed on the ileal digestion rate were studied. Additionally, the viscosity of the contents of the digestive tract was measured (Brookfield digital viscometer LVDV-1).

TABLE 6

| | | | Protein | Dig. Tr. |
|---|---|---|---|---|
| | | Organic Matter | Digestion | Content |
| | | Digestion (%) | (%) | Viscosity (cP) |
| (1) | Control | 71.0 ± 2.2 | 72.9 ± 5.0 | 1.55 ± 0.17 |
| (2) | Koji feed added | 73.1 ± 3.0 | 73.4 ± 4.8 | 1.57 ± 0.19 |
| (3) | Heated feed added | 74.6 ± 1.5 | 74.0 ± 3.7 | 1.38 ± 0.09 |
| | (2) & (3) vs. (1) | * | NS | NS |

Ileal Digestion Rate (%) = 100 − [100 × (Cr₂O₃ in feed)/(Cr₂O₃ in ileal content) × (nutrients in ileal content)/(nutrients in feed)]

There was not much difference in the viscosity of the contents of the digestive tract, but a remarkable improvement was observed in the digestion rate of organic matter.

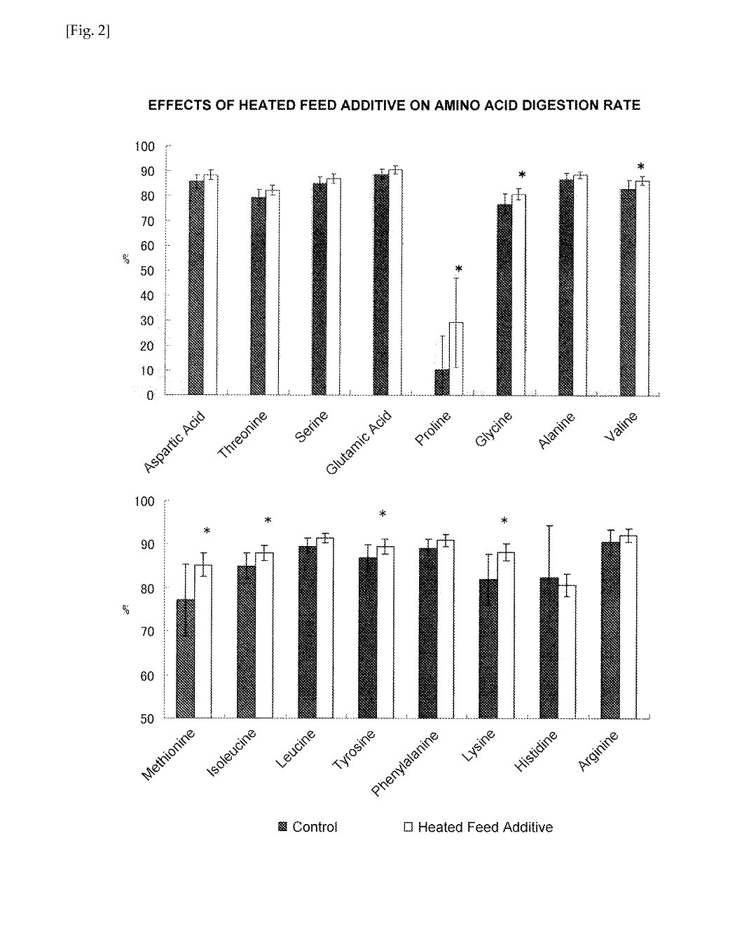

Furthermore, the amino acid digestion rate of the heated feed was studied (Jasco Amino Acid Analyzing System, Jasco International). The results are shown in FIG. 2. The feed composition of the present invention had an increased amino acid digestion rate.

Therefore, the feed composition of the present invention is effective for improving productivity and digestion rate. Additionally, similar effects were achieved for the feed composition of the present invention when further subjected to a heating treatment.

On the other hand, the feed composition of the present invention wherein 0.05 wt % of Aspergillus koji was added to the entire feed composition showed weight increase effects greater than those for the feed composition containing at least 10 wt %. The optimal Aspergillus koji content for weight increase was about 0.05 wt % with respect to the total weight of the feed composition.

### EXAMPLE 3

A feed composition obtained by adding 0.05 wt % each of wheat bran koji and shochu effluent koji (koji having wheat bran and shochu effluents as the substrates) to a common feed composition was fed to chickens. Additionally, a feed composition consisting only of a common feed composition was fed to chickens as a control.

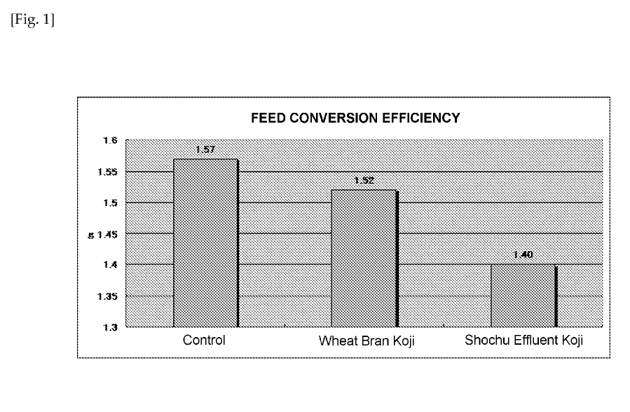

The amount of the feed composition necessary for a weight increase of 1 g in the chickens was calculated. The results are shown in a graph (see FIG. 1).

When 0.05 wt % of koji was added, the feed demand decreased, and in particular, there was a sharp decrease in the feed demand when shochu effluent koji was added.

The blood triglyceride levels of the chickens were measured.

In the chickens fed the feed composition of the present invention, a decrease in the blood triglycerides was observed. Triglyceride levels become high in instances of obesity and hepatic steatosis. While the blood triglycerides are reduced also when there is a reduction in the liver function, no decreases in the liver function were observed.

The feed composition of the present invention was found to improve the meat quality.

1-17. (canceled)

18. A feed composition comprising 0.01-1 wt % of a koji obtained by growing Aspergillus on a substrate containing a substance anaerobically fermented by a yeast.

19. A feed composition in accordance with claim 18, wherein the koji is obtained by growing Aspergillus on a substrate containing wheat bran and a substance anaerobically fermented by a yeast.

20. A feed composition in accordance with claim 18, wherein the substance anaerobically fermented by a yeast is a residue remaining after extracting alcohol from a substance that has been subjected to anaerobic fermentation by a yeast in the production of alcohol.

21. A feed composition in accordance with claim 18, wherein the koji comprises at least 0.05 μg/mg of glucosamine by dry weight of the koji.

22. A feed composition in accordance with claim 18, wherein the Aspergillus is one or more types chosen from the group consisting of Asp. oryzae, Asp. awamori and Asp. sojae.

23. A feed composition in accordance with claim 18, for the purpose of increasing the weight of livestock.

24. A method of raising livestock by feeding the livestock a feed composition obtained by adding, to a common feed composition, koji in an amount of 0.01-1 wt % with respect to the total weight of the feed composition, wherein the koji is obtained by growing Aspergillus on a substrate containing a substance anaerobically fermented by a yeast.

25. A method in accordance with claim 24, wherein the koji is obtained by growing Aspergillus on a substrate containing wheat bran and a substance anaerobically fermented by a yeast.

26. A method in accordance with claim 24, wherein the substance anaerobically fermented by a yeast is a residue remaining after extracting alcohol from a substance that has been subjected to anaerobic fermentation by a yeast in the production of alcohol.

27. A method in accordance with claim 24, wherein the koji comprises at least 0.05 μg/mg of glucosamine by dry weight of the koji.

28. A method in accordance with claim 24, wherein the Aspergillus is one or more types chosen from the group consisting of Asp. oryzae, Asp. awamori and Asp. sojae.

29. A feed composition additive obtained by growing Aspergillus on a substrate containing a substance anaerobically fermented by a yeast, used for production of a feed composition, to be added to a common feed composition in an amount of 0.01-1 wt % with respect to the total weight of the feed composition.

30. A feed composition additive in accordance with claim 29, obtained by growing Aspergillus on a substrate containing wheat bran and a substance anaerobically fermented by a yeast.

31. A feed composition additive in accordance with claim 29, wherein the substance anaerobically fermented by a yeast is a residue remaining after extracting alcohol from a substance that has been subjected to anaerobic fermentation by a yeast in the production of alcohol.

32. A feed composition additive in accordance with claim 29, comprising at least 0.05 μg/mg of glucosamine by dry weight.

33. A feed composition additive in accordance with claim 29, wherein the Aspergillus is one or more types chosen from the group consisting of Asp. oryzae, Asp. awamori and Asp. sojae.

34. A feed composition additive in accordance with claim 29, for increasing the weight of livestock.
